(19) United States
(12) Patent Application Publication
(10) Pub. No.: US 2003/0126291 A1
(43) Pub. Date: Jul. 3, 2003

(54) Method and message distributor for routing requests to a processing node

(76) Inventors: Ben B. Wang, Plano, TX (US); Rayappu F. Joseph, Plano, TX (US); Seshadri Sathyanarayan, Allen, TX (US); Zhiyong Zhang, Plano, TX (US); John P. Larkins, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/035,402

(22) Filed: Dec. 28, 2001

(51) Int. Cl. G06F 15/16

(52) U.S. Cl. 709/245

(57) ABSTRACT

A method of addressing a node in a network comprising reading an identifier, translating the identifier into a group identification representative of a plurality of identifiers, indexing an address table with the group identification, and mapping the identification to a first node of the network is provided. A message distributor for processing an identifier and routing the identifier to a processing node comprising a translation module for receiving the identifier and converting the identifier into one of a plurality of group identifications, and a first table including a plurality of records each indexable by one of the plurality of group identifications, an indexed record including an element having a first address of the processing node is provided.

### TECHNICAL FIELD OF THE INVENTION

This invention relates to data communications and, more particularly, to a method, node, and message distributor for mapping message requests to a processing node.

### BACKGROUND OF THE INVENTION

Scalability is a basic system requirement for many modern large carrier and enterprise telecommunication systems. System scalability is often achieved through a system with a multiple nodes that distribute processing and/or data storage. Distributed architectures may also involve a message distributor that routes incoming processing requests to different processing nodes. For example, a distributed memory database system involves several processing nodes that contain sub-sets of subscriber, or user, data and a front-end message distributor that routes incoming requests to the appropriate processing node.

Typical message distributors use statically defined table look-ups that map subscriber identifications (IDs), or another identifier, to a particular processing node and often have large requisite memory. Modem large carrier grade systems may support millions of subscribers and the required memory for providing a corresponding routing table may be gigabytes in size. Interrogations of routing tables of such scale require large processing capacities and often result in capacity bottlenecks for large carrier systems. Additionally, message routing functionality is often replicated, with the exact information, configuration, and memory requirements, across multiple message distributors to provide system redundancy. Provisioning and maintenance of large routing tables and synchronization of multiple redundant tables across message distributors increases the complexity and cost of operation of the system. Recovery of large routing tables, such as after system failure, is often time consuming and thus reduces system availability.

Static table lookup techniques are most effective when the tables are small and the data searched therein is numerical, e.g. IMSI, MS-ISDN, etc. New applications that utilize text-based lookups of varying length, such as high capacity session initiation protocol (SIP) registrars used to facilitate provisioning of location services in mobile networks, result in increasingly inefficient static table lookups as the size of the table increases.

### SUMMARY OF THE INVENTION

In accordance with an embodiment of the present invention, a method of addressing a node in a network comprising reading an identifier, translating the identifier into a group identification representative of a plurality of identifiers, indexing an address table with the group identification, and mapping the identification to a first node of the network is provided.

In accordance with another embodiment of the present invention, a message distributor for processing an identifier and routing the identifier to a processing node comprising a translation module for receiving the identifier and converting the identifier into one of a plurality of group identifications, and a first table including a plurality of records each indexable by one of the plurality of group identifications, an indexed record including an element having a first address of the processing node is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a general message distributor configuration in which the present invention may be implemented,

FIG. 2 illustrates a routing table that may be utilized for addressing a processing node according to the prior art;

FIG. 3 illustrates a table including logical groups that may be assigned to subsets of records according to an embodiment of the present invention;

FIG. 4A illustrates a table in a configuration with a hashing function that facilitates group indexing of the table according to an embodiment of the present invention;

FIG. 4B illustrates a table in a configuration with a hashing function that facilitates group indexing of the table according to an embodiment of the present invention;

FIG. 5 is a block diagram of a network that may provide a session initiation protocol communication session between two or more terminal devices;

FIG. 6 is a block diagram of an exemplary network in which the present invention may be employed for advantage; and

FIG. 7 illustrates a simplified session initiation protocol initiation including a proxy server implementation of an embodiment of the present invention.

### DETAILED DESCRIPTION OF THE DRAWINGS

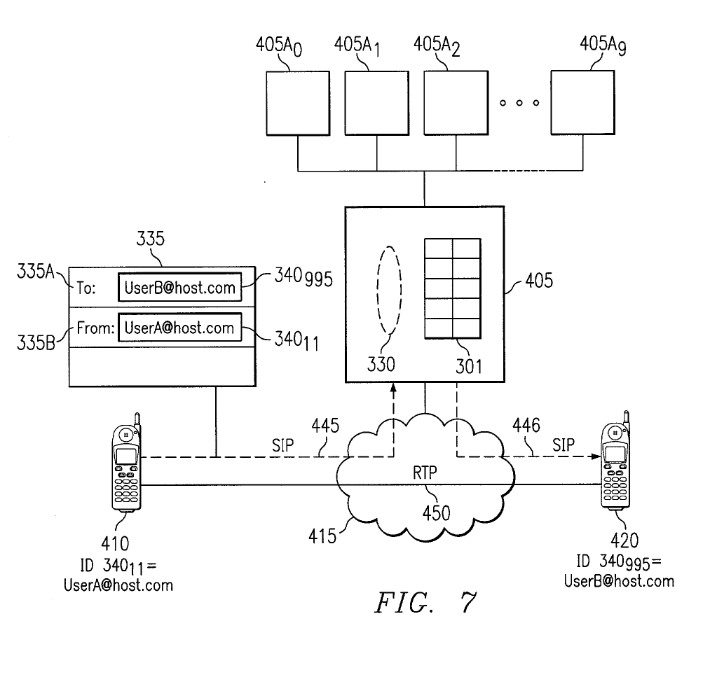

The preferred embodiment of the present invention and its advantages are best understood by referring to FIGS. 1 through 7 of the drawings, like numerals being used for like and corresponding parts of the various drawings.

With reference to FIG. 1, there is shown a block diagram of a general message distribution configuration in which the present invention may be implemented. A message distributor (MD) 10 interfaces with a plurality of processing nodes (PNs) 20A-20N. Message distributor 10 may be implemented as a computer workstation or other processing element. Each of PNs 20A-20N are interconnected with MD 10 via an interface 30. PNs 20A-20N may be implemented as external nodes, such as computer workstations. Accordingly, interface 30 may comprise a network medium, such as an Ethernet. Alternatively, PNs 20A-20N may be disposed within MD 10 and may be respectively implemented as storage devices, such as magnetic disks, optical disks, solid state memory devices, or another digital data storage device, or PNs 20A-20N may be implemented as processing elements interconnected with or operable to communicate with a storage device. Accordingly, interface 30 may be implemented as an internal interface, such as a local bus, of MD 10.

A message 40 may be input to MD 10 by any one of a number of techniques, such as, but not by way of limitation, radio frequency input, electrical communication via a communication medium such as an electrical conductor, an optical input or another mechanism. Message 40 may include an identifier that is read by MD 10. MD 40 may establish a connection with a PN in response to reading message 40 thereby routing an originator of message 10 to one of PNs 20A-20N or an entity in communication therewith.

In general, MD 10 may perform either a persistent routing or a stateful routing of message 40 to one of PNs 20A-20N. As used herein, “persistent” routing indicates that a particular PN, or one of a particular subset of PNs, of the plurality of PNs 20A-20N interconnected with MD 10 must be addressed by MD 10 to properly route message 40. “Stateful” routing, as used herein, indicates that the particular PN 20A-20N to which message 40 is routed to is irrelevant but subsequent communications with an originator of message 40 must be performed with the original PN to which message 40 is routed.

Commonly, persistent routing is performed when contents of message 40 require routing to a particular PN having contents or processing capabilities associated with message 40 contents. For example, message 40 may include a subscriber identifier and PNs 20A-20N may comprise respective databases having records of subscriptions. Due to the size of the database, the contents thereof may be distributed across the plurality of PNs 20A-20N. Message 40 may further include a request for information stored in a record associated with a particular subscriber identified by a subscriber identifier contained in message 40. Accordingly, message 40 must be routed to the proper PN maintaining the requested information. To facilitate routing to the proper PN 20A-20N, MD 10 may maintain a routing table, or other distribution mechanism, that is indexed by a datum, such as a subscriber identifier (ID), within message 40.

Stateful routing may be utilized in numerous scenarios including streaming media routing with content maintained on an Internet site, for example. PNs 20A-20N may represent individual workstations maintaining streaming media content that is accessed by MD 10, such as a web server front end. To support a large number of concurrent users, duplicative content may be maintained by the plurality of PNs 20A-20N. Message 40 may include a request for content that is commonly maintained on PNs 20A-20N (or a subset thereof). Because content maintained by PNs 20A-20N is duplicative, any one of PNs 20A-20N may be accessed by MD 10 for routing content to an originator of message 40. MD 10 may choose to route message 40 to a particular PN 20A-20N based on a respective processing capacity, or other metric, of PNs 20A-20N. However, once a particular PN 20A-20N is addressed by MD 10, the same PN 20A-20N must be addressed for the duration of a session maintained by the originator of message 40. Such stateful routing may be necessary for a number of reasons, such as queuing and buffering of streaming data that may be performed by the addressed PN 20A-20N and due to subsequent messages being transmitted by the originator of message 40 relating to a connection with the PN 20A-20N terminating the connection.

As mentioned hereinabove, conventional message distributors use statically defined table look-ups that map subscriber identifications (IDs) to a particular processing node and often have large requisite memory. Modern large carrier grade systems may support millions of subscribers and the required memory for providing a corresponding routing table may be gigabytes in size. In general, processing capacities required to search a static lookup table are directly related to the table lookup size. Further exacerbating the problem of efficiently routing a request to a particular PN is the fact that IDs used to index a routing table are often text-based and may be variable in length, thus further increasing processing requirements and lookup times.

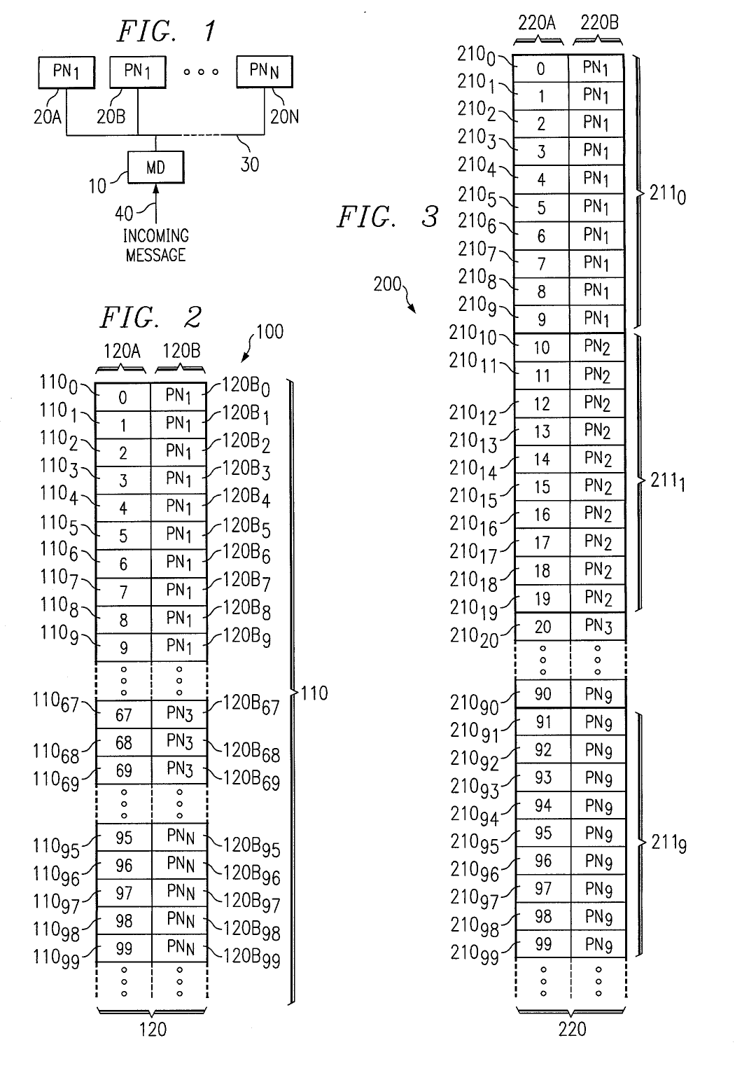

In FIG. 2, there is shown a routing table 100 that may be utilized for addressing a PN 20A-20N according to the prior art. Routing table 100 includes a plurality of records 110 comprised of elements of one or more fields 120. Each field 120A and 120B comprise data having a common attribute. For example, field 120A may comprise elements maintaining data therein associated with a particular identifier, such as a subscriber ID. Field 120B may comprise elements maintaining data therein that define a particular PN 20A-20N associated with an ID maintained in a corresponding element of field 120A. In the present example and those hereinbelow, a table element value of the form PN, indicates an address, such as an IP address, a URL, an internal bus address, or another designation defining the location of a particular PN. Elements maintained in a particular field 120A may be referred to as key values and are used as indices to retrieve the contents of an associated element in another field 120B of an indexed record. For example, a key value (“3”) of record 110₃ may be used as an index to retrieve the contents of field 120B in an element 120B₃ within indexed record 110₃. Contents of elements within field 120A may comprise an ID, such as that assigned to a subscriber or a particular connection with MD 10, and contents of elements within field 120B may comprise an identifier, such as an address, of a particular PN 20A-20N. In the illustrative example, a plurality of IDs, such as IDs 0-9, may index a particular PN, such as PN 20A having an address PN₁. As mentioned hereinabove, elements of key field 120A may be numerical-based or text-based. Text-based key values, such as SIP uniform resource locators (URLs), generally require more processor-intensive lookups. Common routing tables may have tens of thousands of elements in fields 120A-120B and system resources required to perform a lookup therein may be significant.

The present invention improves on prior art lookup techniques by effectively subdividing records of a routing table into sub-groups and searching only the sub-group for an appropriate index to a desired record element. For example, table 200 includes fields 220A and 220B and records 210, as illustrated in FIG. 3, and logical groups 211₀-211₉ may be assigned to subsets of records 210₀-210₉₉. For example, group 211₀ includes records 210₀-210₉. Each record of a group 211₀-211₉ includes a field element, such as field elements of field 220B, having a common value therein. For example, each record 210₀-210₉ of group 211₀ contains field elements of field 220B having an identical value, such as an address of PN 20A, therein. Thus, key values of records of groups 211₁-211₉ may be reassigned a common value because input to table 200 with any key value of a record assigned to group 211₀-211₉ will result in indexing of an identical value from field 220B. For example, input to table 200 with any of key values 0-9 will result in an identical value indexed from field 220B, namely “PN1” in the illustrative example.

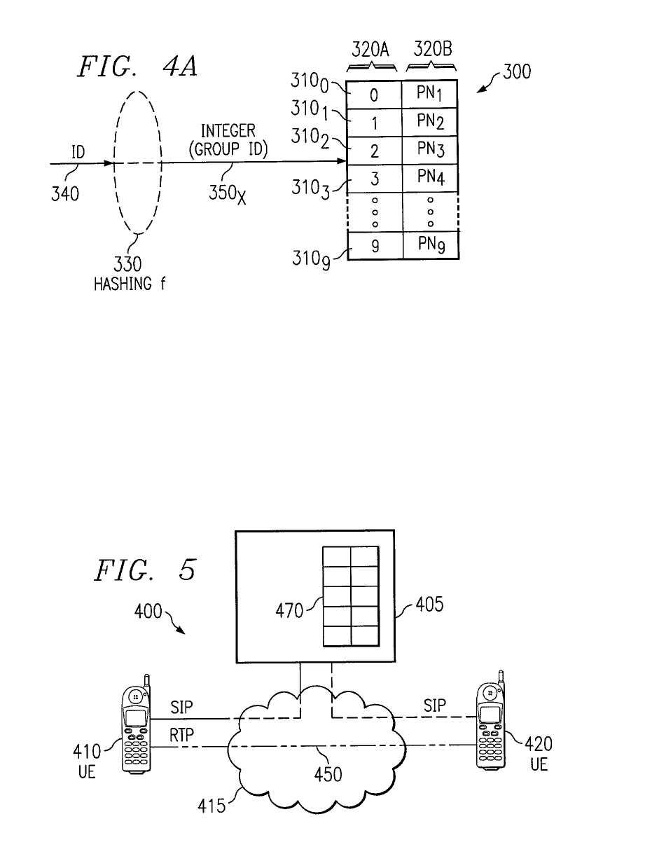

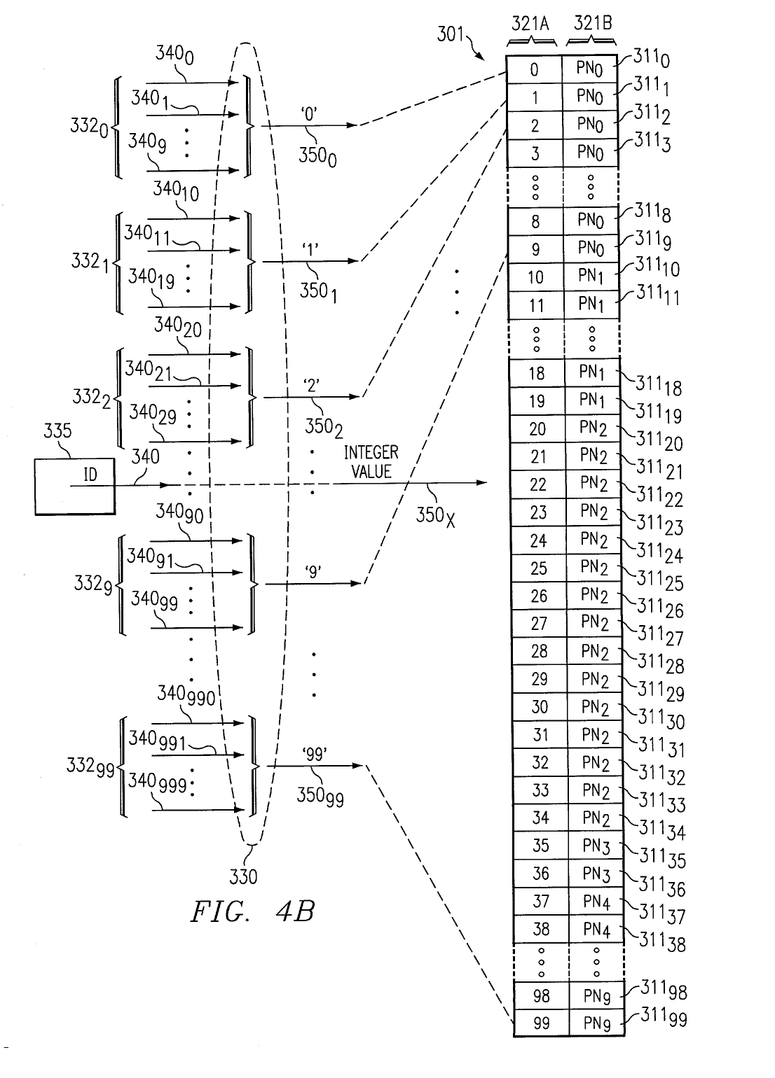

In FIG. 4A, there is illustrated a table 300 in a configuration with a hashing function 330, or another translation module, that facilitates group indexing of a table 300 according to an embodiment of the present invention that allows for a reduced table 300 size. Table 300 and hashing function 330 may be maintained by MD 10 in a storage device, such as a magnetic disk, optical disk, solid state memory device, or other mechanism operable to store data thereon, and may be retrieved and/or accessed by a processing element of MD 10. Hashing function 330 is preferably maintained by MD 10 as a computer executable instruction set and is executable by a processing element thereof. Table 300 includes a field 320A of elements containing key values and a field 320B of elements that may be indexed by a key value of an associated record 310₀-310₉. A message 340, such as an ID, may be input into hashing function 330. Hashing function 330 outputs an integer value 350ₓ that may be used as an index to table 300. Accordingly, multiple records of prior art table 200 may be replaced by a single record of table 300. Assume the ID contained in message 340 has a numerical value between 0-99. A route lookup of a prior art table configuration, such as table 200, requires performing a search of all elements of field 220A until a key value is matched with the ID of message 340. As mentioned hereinabove, a plurality of key values, and thus ID values of a message 340, may result in an identical value returned from an indexed field 220B. Hashing function 330 operates to generate an integer value 350ₓ from an input ID. Notably, hashing function 330 is operable to generate one or more integer values of which a particular integer value 350ₓ may be generated from a plurality of input IDs. For example, hashing function 330 may be configured to output a common integer value 350ₓ, such as an integer value of “0”, from a plurality of input IDs, such as input IDs “0”-“9”. Thus, each record 210₀-210₉ of prior art table 200 may be equivalently represented by hashing function 330 and a single record 310₀ of table 300.

With reference now to FIG. 4B, there is shown a table 301 in a configuration with hashing function 330 that facilitates group indexing of table 301 according to an alternative embodiment of the present invention that allows for a reduced table 301 size comparable with a conventional routing table having similar routing capabilities. Table 301 and hashing function 330 may be maintained by MD 10 in a storage device, such as a magnetic disk, optical disk, solid state memory device, or other mechanism operable to store data thereon, and may be retrieved and/or accessed by a processing element of MD 10. Hashing function 330 is preferably maintained by MD 10 as a computer executable instruction set and is executable by a processing element thereof. Table 301 includes a field 321A of elements containing key values and a field 321B of elements that may be indexed by a key value of an associated record 311₀-311₉₉. A message 335 including an ID 340 may be input into hashing function 330. Hashing function 330 outputs an integer value 350ₓ that may be used as an index to table 300. In the hashing function 330 and table 301 configuration of FIG. 4B, hashing function 330 is configured to convert a plurality of identifiers, such as IDs 340 included within messages 335, into one of a plurality of integer values 350ₓ that may be used to index table 301. Notably, a plurality of key values maintained in elements of key field 321A may index a common element value of field 321B, such as an element value of “PN₀”Assume ID 340 contained in message 335 has a numerical value between 0-999. A route lookup of a prior art table configuration, such as table 200, requires performing a search of all elements of field 220A until a key value is matched with the ID of message 340. As mentioned hereinabove, a plurality of key values, and thus ID values of a message 340, may result in an identical value returned from an indexed field 220B. Hashing function 330 operates to generate an integer value 350ₓ from an input ID 340. Hashing function 330 is operable to generate one or more integer values 350₀-350₉₉ of which a particular integer value 350ₓ may be generated from a plurality of input IDs. For example, hashing function 330 may be configured to output a common integer value 350ₓ, such as an integer value 350₀ of “0”, from a plurality of input IDs, such as input IDs 340₀-340₉ (group 332₀). Furthermore, the hashing function 330, as illustrated in FIG. 4B, and table 301 may be configured to output another integer value, such as an integer value 350₁ of “1”, that is commonly generated from another plurality of input IDs, such as input IDs 340₁₀-340₁₉ (group 332₁), and that results in indexing a common element value of field 321B (element value of “PN₁”) of a record, for example record 311₁, having a key value matching with the output integer value 350₁. Likewise, other groups 332₂-332₉₉ of respective input IDs may result in output integer values 350₂-350₉₉ that may be used as indices to table 301.

In the illustrative example, hashing function 330 is configured to convert any one of 1000 input IDs (340₀-340₉₉₉) into one of 100 integer values (350₀-350₉₉). Each of the integer values 350₀-350₉₉ may be used as a key value that is input into table 301 and that indexes an element of field 321B. In the configuration illustrated in FIG. 4B, elements of field 321B have one of 10 values, namely “PN₀”-“PN₉”. Accordingly, one or more integer values 350₀-350₉₉ output from hashing function 330 may be used to index a particular field 321B element value. For example, integer values 350₀-350₉ index a common field 321B element value of PN₀. Notably, there is no requisite correspondence between the number of key values that map to a particular field 321B element value. For example, fifteen integer values ‘20’-‘34’ all commonly index a field 321B element value of PN₂ while only two integer values ‘35’ and ‘36’ commonly index a field 321B element value of PN3. Thus, the hashing function 330 and table 301 configuration of FIG. 4B may provide particular advantage in such scenarios requiring load balancing among processing nodes that are addressed by indexed elements, such as field 321B elements, of table 301.

The present invention may provide particular advantage when implemented in routing scenarios requiring unique identifiers, such as a session initiation protocol (SIP) communication session. With reference to FIG. 5, there is shown a block diagram of a network 400 that may provide a SIP communication session between two or more terminal devices. SIP is a text-based application-layer control protocol for creating, modifying, and terminating multimedia conferencing over an Internet protocol (IP) network. A first user (also referred to herein as the ‘originator’) using a user equipment (UE) 410 may initiate a SIP session with another user (also referred to herein as the ‘destination subscriber’) using a second UE 420 by transmitting an INVITE message to a server 405, for example a proxy server, a redirect server, or another routing device, interconnected with a packet network 415, such as the Internet. In general, the INVITE message will include a unique identifier of the originator and/or a contact address of UE 410 as well as a unique identifier of the destination subscriber and/or a contact address of destination UE 420 in fields thereof, such as a respective ‘To’ and ‘From’ header field of the INVITE message. The respective identifiers of the originator and the destination subscriber generally are text based and may take the form of: UserX@host.com, for example. Server 405 may thereafter determine, for example by interrogation of a routing table 470 maintained thereby, a path to destination UE 420. In a SIP network, the destination subscriber must generally first register with the SIP network and provide a contact address of UE 420 to the network prior to another user being able to engage in a communication session with the destination subscriber via UE 420. Upon determination of a route to UE 420, server 405 may forward the session request to UE 420. Thereafter, UE 420 may respond to server 405 with an acknowledgment which is forwarded to the originating UE 410. A session, such as a real-time transport protocol (RTP) session 450, may then be established between UE 410 and UE 420.

As the number of subscribers supported by network 400 becomes large, the requisite processing capacity for interrogating table 470 may become unmanageable or impractical. Furthermore, location lookups performed by server 405 are text-based due to text-based identifiers, such as SIP URLs, assigned to the subscribers, such as the originator and the destination subscriber. As mentioned hereinabove, text-based table lookups are inherently less efficient than numerical-based lookups and further burden processing elements of server 405.

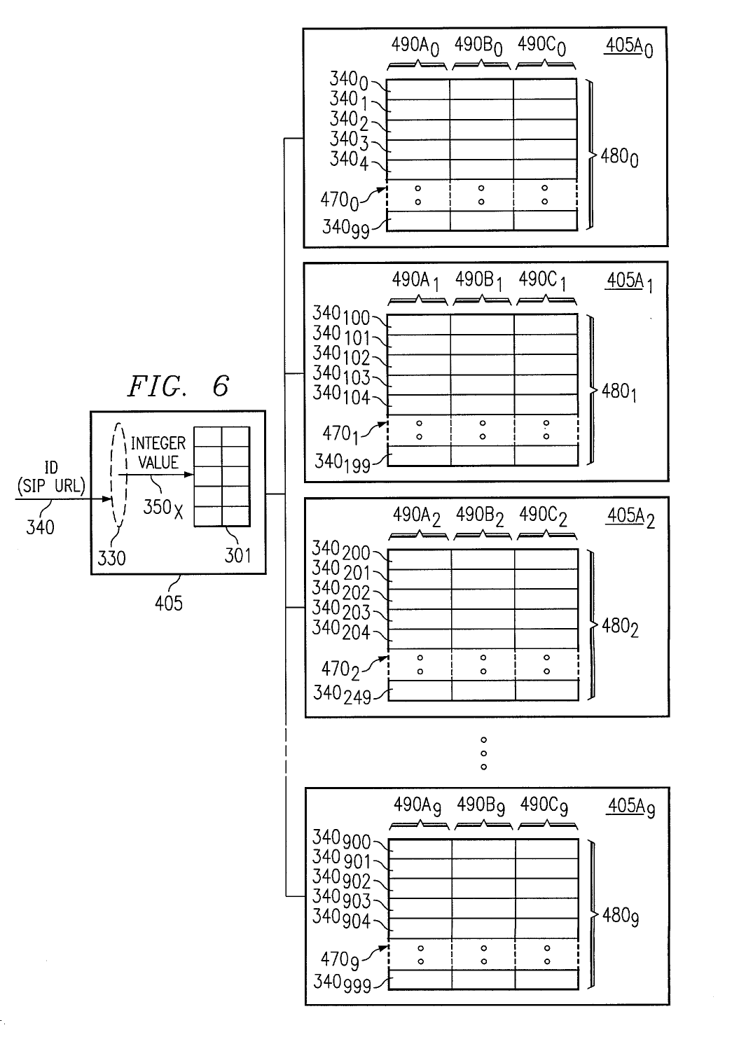

To reduce the processing requirements and/or inefficiency of performing text-based route lookups to connect UEs 410 and 420, server 405 may be implemented as a front end proxy server and may employ a distributed location lookup table 470₀-470₉ across multiple nodes 405A₀-405A₉, as illustrated in FIG. 6. Nodes 405A₀-405A₉, such as magnetic disks, optical disks, solid state memory devices, or workstations interconnected with server 405, each maintain a respective table 470-₀-470₉. Tables 470₀-470₉ maintain subsets of information of subscribers serviced by network 400 and collectively provide subscriber information of subscribers for which front end proxy server 405 is assigned routing responsibilities therefor. Each table 470₀-470₉ may include respective records 480₀-480₉ each including element/s within one or more sets of fields 490A₀-490C₀-490A₉-490C₉ of subscriber information (such as location information of a particular subscriber, service parameters, authentication parameters, or other information) related to subscribers serviced by network 400. Tables 470₀-470₉ include a respective key field 490A₀-490A₉ each including elements with key values, such as identifiers of subscribers, used to index other elements of associated records 480₀-480₉. In the illustrative embodiment, key fields 490A₀-490A₉ include elements having unique SIP URLs stored therein. Thus, each ID 340₀-340₉₉₉ in FIG. 6 is representative of a unique text-based SIP URL assigned to a particular subscriber that may be serviced by network 400. To properly interrogate a table 470₀-470₉, server 405 must therefore be able to route a request, such as an INVITE message including an originator and/or destination ID, to the proper table 470₀-470₉ maintaining a record assigned to the destination subscriber, that is server 405 must be capable of performing persistent routing to nodes 470₀-470₉ to facilitate session initiation between UEs. In the illustrative example, table 470₀ includes records 480₀ assigned to subscribers identified by IDs 340₀-340₉₉, table 470₁, includes records 480₁ assigned to subscribers identified by IDs 340₁₀₀-340₁₉₉, and table 470₂ includes records 480₂ assigned to subscribers identified by IDs 340₂₀₀-340₂₄₉. Tables 470₃-470₈ (not shown) collectively include records 480₃-480₈ (not shown) assigned to subscribers identified by IDs 340₂₅₀-340₈₉₉. Table 470₉ includes records 480₉ assigned to subscribers identified by IDs 340₉₀₀-340₉₉₉.

Server 405 may maintain an instance of table 301 including records 311₀-311₉₉ comprised of elements of fields 321A and 321B. Field 321A may include key values, and in the illustrative example key field 321A includes key values 0-99. Field 321B contains elements that may be indexed by a key value. In the present example, each element of field 321B includes an address, or another identifier, of a node 405A₀-405A₉. An instance of hashing function 330 maintained and executed by front end proxy server 405 is operable to receive a text-based identifier 340, such as a SIP URL, input thereto and convert the text-based identifier into an integer value 350ₓ. Integer ID 350 may be used by server 405 as a key value to interrogate table 301. Accordingly, server 405 searches key field 321A with integer value 350ₓ and, upon determining a correspondence between an element value in key field 321A and integer value 350ₓ, retrieves a value from a record 311₀-311₉₉, for example from an element of field 321B, having the key field 321A element in correspondence with integer value 350ₓ. Thus, hashing function 330 may be configured to hash a plurality of unique text-based identifiers into a common one of a plurality of integer values. In the illustrative example, SIP registrar/location server data is distributed across ten tables 470₀-470₉ and table 301 includes one-hundred (0-99) unique key field 321A element values. Accordingly, hashing function 330 may be configured to hash valid SIP URLs into one of one-hundred integer values 350ₓ that may be used to index one of ten addresses (PN₁-PN₉) of nodes 405A₀-405A₉ from a field 321B of table 301. Thereafter, server 405 may route a message that includes ID 340 therein to the appropriate node where the ID 340 may be used to index a subscriber record therein.

With reference to FIGS. 4B, 6 and 7, a simplified SIP session initiation including a proxy server implementation of an embodiment of the present invention is described. In the present example, the originator accessing network 500 via UE 410 has a unique, text-based SIP URL of UserA@host.com and the destination subscriber accessing network 500 via UE 420 has a unique, text-based SIP URL of UserB@host.com. UE 410 may initiate a SIP session with UE 420 by transmitting an INVITE message 335 to front end proxy server 405. INVITE message 335 includes a To header 335A and a From header 335B including a respective ID 340₉₉₅ (UserB@host.com) and 340₁₁ (UserA@host.com). In the present example, ID 340₉₉₅ is representative of the unique, text-based SIP URL assigned to the destination subscriber, that is ID 340₉₉₅ is UserB@host.com, and ID 340₁₁ is representative of the unique, text-based SIP URL assigned to the originator, that is ID 340₁₁ is UserA@ghost.com. ID 340₉₉₅ may be parsed from INVITE message 335 upon reception thereof by front end proxy server 405 and thereafter input into hashing function 330. ID 340₉₉₅ is one of the plurality of IDs included in group 332₉₉ and, according to the exemplary configuration of hashing function 330 described with reference to FIG. 4B, is hashed into integer ID 350₉₉ (‘99’). Front end proxy server 405 may then input integer value 350₉₉ into table 301 thereby indexing record 311₉₉. An element value of record 311₉₉, such as an element value of field 321B, may then be retrieved by front end proxy server 405. In the present example, field 321B of indexed record 311₉₉ contains an address PN₉ of node 405A₉. Server 405 may then interrogate table 470₉ with ID 340₉₉₅ to obtain subscriber data therefrom. For example, node 405A₉ may parse ID 340₉₉₅ from INVITE message 335 and interrogate table 470₉ using the parsed ID 340₉₉₅ (UserB@host.com) as a key for matching a key field 490A₉ element. Upon determining a match between a key field 490A₉ element and ID 340₉₉₅, element/s of a record indexed by ID 340₉₉₅ may be retrieved and/or forwarded to front end proxy server 405 for processing. Information obtained from elements of a record 480₉ indexed by ID 340₉₉₅ may include authentication parameters, subscription parameters, location information, and/or other information related to the destination user necessary for front end proxy server 405 to establish a connection with UE 420. Thereafter, front end proxy server 405 may forward INVITE message 335 to UE 420 via a SIP connection 446. Acknowledgment messages may be exchanged between front end proxy server 405 and UEs 410 and 420 and a communication session, such as an RTP session 450, may be established and terminated by UEs 410 and 420.

The table lookup technique of the present invention may find application in numerous technologies involving one or more distribution nodes that process incoming requests and perform routing to different processing nodes. For example, distributed-in memory database systems may include several processing nodes that contain sub-sets of data and a front-end message distributor that routes incoming requests to an appropriate processing node maintaining a requested sub-set of data. By utilizing a distributed table configuration according to the present invention, incoming requests may be hashed into group identifiers used to index one of a plurality of tables. The processing requirements for performing table lookups are accordingly reduced. Additionally, the capacity of requests able to be handled by such a system are increased due to shorter lookup times had by implementation of the invention. Furthermore, since the lookup function may no longer be a performance bottleneck, system scalability may be achieved simply by adding new router hardware. The present invention may also be employed in numerous mobile telecommunication entities for facilitating increased scalability thereof. For example, the distributed lookup technique may be employed in SIP registers, home location registers, mobility presence servers and web switching devices. In general, the techniques of the present invention may be applied to any message distribution system requiring persistent and/or stateful routing.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. A method of addressing a node in a network, comprising:
reading an identifier;
translating the identifier into a group identification representative of a plurality of identifiers;
indexing an address table with the group identification; and
mapping the group identification to a first node of the network.

2. The method according to claim 1, wherein translating the identifier into a group identification further comprises translating the identifier into one of a plurality of group identifications.

3. The method according to claim 1, wherein indexing an address table with the group identification further comprises indexing a record of the table having a field element corresponding to the group identification.

4. The method according to claim 1, wherein mapping the group identification to a first node further comprises mapping the group identification to a first node of a plurality of nodes of the network.

5. The method according to claim 1, wherein reading an identifier further comprises reading a text-based identifier.

6. The method according to claim 1, wherein translating the identifier further comprises translating the identifier by a hashing function.

7. The method according to claim 1, wherein translating the identifier into a group identification further comprises translating the identifier into a numerical-based group identification.

8. A message distributor for processing an identifier and routing the identifier to a processing node, comprising:
a translation module for receiving the identifier and converting the identifier into one of a plurality of group identifications; and
a first table including a plurality of records each indexable by one of the plurality of group identifications, an indexed record including an element having a first address of the processing node.

9. The message distributor according to claim 8, wherein the translation module is a hashing function.

10. The message distributor according to claim 8, wherein the identifier is a text-based identifier and the group identification is a numerical-based identification.

11. The message distributor according to claim 8, wherein the translation module is operable to translate a plurality of identifiers into a common group identification.

12. The message distributor according to claim 8, further comprising:
a processing element; and
a memory module maintaining the translation module and the first table, the translation module maintained by the memory module as an instruction set executable by the processing element.

13. The message distributor according to claim 8, wherein the identifier is included in a message received by the message distributor, the message routed to the processing node by the message distributor upon indexing of the record.

14. The message distributor according to claim 8, wherein the message distributor is operable to receive a second identifier and the translation module is operable to translate the second identifier into a second group identification of the plurality of group identifications, a second record indexed by the second group identification.

15. The message distributor according to claim 14, wherein the second record includes a second element having a second address.

16. The message distributor according to claim 15, wherein the second address is equivalent to the first address.

17. The message distributor according to claim 15, wherein the second address is different than the first address.

18. The message distributor according to claim 8, further comprising an interface with a plurality of processing nodes.

19. The message distributor according to claim 18, wherein the interface is a network interface.

20. The message distributor according to claim 18, wherein the interface is an address bus of the message distributor.
